(19) United States
(12) Patent Application Publication
(10) Pub. No.: US 2006/0269084 A1
(43) Pub. Date: Nov. 30, 2006

(54) Electronic apparatus

(75) Inventors: Makoto Yamaguchi, Kanagawa (JP); Kazuyuki Saito, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/393,273

(22) Filed: Mar. 30, 2006

(30) Foreign Application Priority Data
May 27, 2005 (JP) P2005-154928

(51) Int. Cl. H04R 3/00

(52) U.S. Cl. 381/111

(57) ABSTRACT

According to one embodiment, an electronic apparatus comprises: a speaker; a sound circuit section that drives the speaker; and a power supply section which is powered by an AC source, which comprises a battery, and which can feed DC power to the sound circuit section by power of the AC source or the battery. When the DC power is fed by the AC source, the power supply section feeds the sound circuit section with a first supply voltage supplied from the DC power. When the DC power is fed by the battery, the power supply section feeds the sound circuit section with a second supply voltage which is supplied from the battery. The second supply voltage is lower than the first supply voltage.

### CROSS-REFERENCE TO RELATED APPLICATIONS

This application is based upon and claims the benefit of priority from Japanese Patent Application No. 2005-154928, filed on May 27, 2005, the entire contents of which are incorporated herein by reference.

### BACKGROUND

1. Field

One embodiment of the invention relates to electronic apparatus, and, more particularly, to electronic apparatus configured so as to be driven by a battery and to have an audio function.

2. Description of the Related Art

Electronic apparatus, such as a notebook-type personal computer, in which a sound circuit or a speaker is incorporated, has come into wide use. By virtue of incorporating a sound circuit or a speaker, a function of playing music or video images is provided in addition to an information processing function which has originally been provided in electronic apparatus.

In recent years, a considerable progress in enhancement of multi-functionality of electronic apparatus, such as a notebook-type personal computer, has been made, and electronic apparatus having the function of playing back music or a video as well as the function of receiving television broadcasting has been proposed.

Power consumption has also increased with increasing multi-functionality or enhancement in performance of a CPU of the electronic apparatus. However, portable electronic apparatus, such as a notebook-type personal computer, typically has a battery mode in which the equipment is driven by an internal battery.

A remaining charge of the internal battery is limited, when the equipment is driven in a battery mode, control for reducing power consumption is more strictly required as compared with a case where the same is driven by commercial power.

For instance, it is disclosed by JP-A-2004-172690, for example, that a technique for realizing reduction in power consumption of information processing equipment driven in a battery mode. That is, in a case where the remaining charge of a battery has become low, a program for reducing an extent of operation is selected, thereby decreasing the load placed on a CPU. It is also disclosed by JP-A-2004-172690 that technique reduces power consumption by lowering a volume level of an internal speaker when reduction in power consumption is required.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating an example configuration of the electronic apparatus according to a first embodiment;

FIGS. 2A and 2B are explanatory views describing operations of a sound circuit section according to the first embodiment;

FIG. 3 is an explanatory view describing an example configuration of an amplitude control section according to the first embodiment;

FIG. 4 is a flowchart illustrating a flow of processing performed by a power supply controller according to the first embodiment;

FIG. 5 is a block diagram illustrating an example configuration of the electronic apparatus according to a second embodiment; and

FIG. 6 is a flowchart illustrating a flow of processing performed by a power supply controller according to the second embodiment.

### DETAILED DESCRIPTION

Various embodiments according to the invention will be described hereinafter with reference to the accompanying drawings. In general, according to one embodiment of the invention, an electronic apparatus comprises: a speaker; a sound circuit section that drives the speaker; and a power supply section which is powered by an AC source, which comprises a battery, and which can feed DC power to the sound circuit section by power of the AC source or the battery. When the DC power is fed by the AC source, the power supply section feeds the sound circuit section with a first supply voltage supplied from the DC power. When the DC power is fed by the battery, the power supply section feeds the sound circuit section with a second supply voltage which is supplied from the battery. The second supply voltage is lower than the first supply voltage.

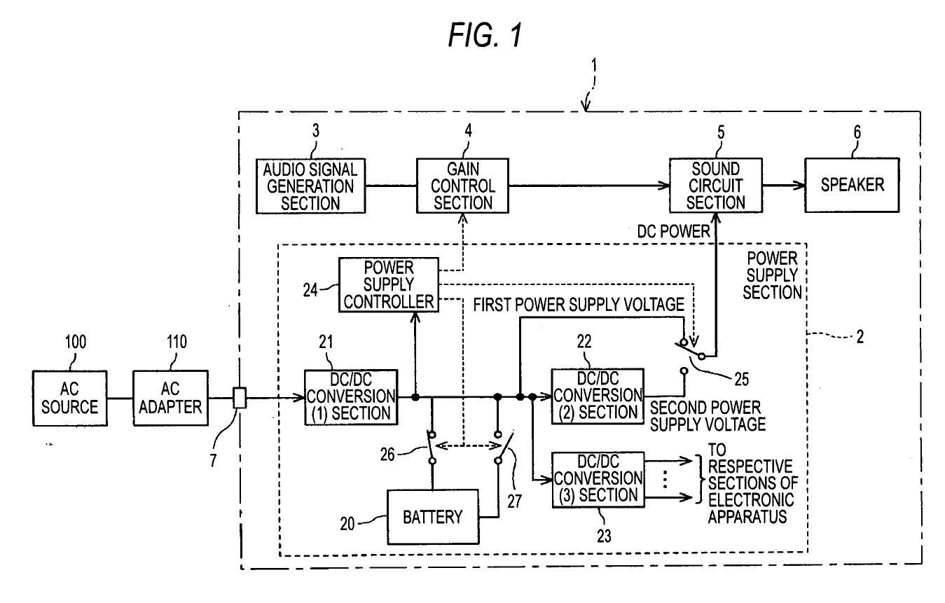

FIG. 1 is a block diagram illustrating an example configuration of electronic apparatus 1 according to a first embodiment.

The electronic apparatus 1 comprises an audio signal generation section 3 for generating an audio signal; a gain control section 4 for controlling amplitude of an audio signal output from the audio signal generation section 3; a sound circuit section 5 for amplifying an audio signal output from the gain control section 4, and driving a speaker 6; and the speaker 6.

In addition, the electronic apparatus 1 includes a power supply section 2 which receives power supply from an external AC source 100 and which incorporates a battery 20.

The electronic apparatus 1 according to the first embodiment other than the sound function thereof is not limited particularly. When, e.g., the electronic apparatus 1 is configured as a notebook-type personal computer, the electronic apparatus 1 has, in addition to the configuration illustrated in FIG. 1, components related to information processing, such as a storage device primarily formed from a CPU, a display device, and a communications interface. However, since these components are not related directly to the first embodiment, they are omitted from the block diagram illustrated in FIG. 1.

In a case where the electronic apparatus 1 is a notebook-type personal computer, or the like, the power supply section 2 generates a variety of types of DC power, and distributes and feeds the same to components related to information processing. However, FIG. 1 explicitly shows only DC power to be fed to the sound circuit section 5, which is directly related to the first embodiment, while omitting therefrom connections to other components.

The power supply section 2 comprises, in a detailed configuration thereof, three DC power conversion sections; that is, a DC/DC conversion (1) section 21, a DC/DC conversion (2) section 22, and a DC/DC conversion (3) section 23. In addition, the power supply section 2 comprises the battery 20, which is rechargeable, and a power supply controller 24 for controlling the entire power supply section 2.

In addition to the above, the power supply section 2 has a charging switch 26 for switching on/off with regard to charging the battery 20; a discharging switch 27 for switching on/off with regard to discharging from the battery 20; and a changeover switch 25 for switching between a first power supply voltage V1 output from the DC/DC conversion (1) section 21 or the battery 20, and a second power supply voltage V2 output from the DC/DC conversion (3) section 23.

Operations of the electronic apparatus 1 configured as above will be described. First, operations of a case where the electronic apparatus 1 is powered by the external AC source 100 will be described.

The power fed from the AC source 100 is converted from AC power into DC power of an appropriate voltage by an AC adapter 110, and thereafter fed to the electronic apparatus 1 by way of a connector 7 included in the electronic apparatus 1.

When the AC adapter 110 is connected to the connector 7, the DC power is converted into the first power supply voltage V1 by the DC/DC conversion (1) section 21 included in the power supply section 2. The DC power output, which is converted into the first power supply voltage V1 and output from the DC/DC conversion (1) section 21, is selected by the changeover switch 25 so as to bypass the DC/DC conversion (3) section 23, and is thereafter fed to the sound circuit section 5.

In many cases, DC power to be fed to the sound circuit section 5 of the electronic apparatus 1, such as a notebook-type personal computer, has a relatively low voltage of, e.g., about 5 V.

In contrast, the electronic apparatus 1 according to the present embodiment is configured such that the DC/DC conversion (1) section 21 generates DC power of, e.g., about 15 V, which is relatively high as compared with that of the related art, and feeds the sound circuit section 5 with this high voltage as the first power supply voltage V1.

Switching of the DC power by the changeover switch 25 is automatically performed by the power supply controller 24.

The power supply controller 24 is formed by incorporating, e.g., a microcomputer and an A/D converter. When the AC source 100 is connected, the first power supply voltage V1 is generated as an output of the DC/DC conversion (1) section 21. The first power supply voltage V1 is converted into a digital value by the A/D converter of the power supply controller 24, whereupon the microcomputer makes a determination as to whether or not the digital value has exceeded a predetermined threshold value.

When the digital value exceeds the predetermined threshold value, the electronic apparatus 1 is determined to be connected with the AC source 100. When the power supply controller 24 determines that the connection with the AC source 100 is established, the power supply controller 24 switches the changeover switch 25 to a bypass path, thereby feeding the first power supply voltage V1 to the sound circuit section 5.

In addition to the above, the power supply controller 24 also controls charging/discharging of the battery 20. When, e.g., the AC source 100 is determined to be connected, the power supply controller 24 switches the charging switch 26 on, thereby charging the battery 20 with power output from the DC/DC conversion (1) section 21. In addition, the power supply controller 24 switches a discharging switch 27 off, thereby stopping discharge from the battery 20.

Meanwhile, when the AC source 100 is not fed to the electronic apparatus 1, the sound circuit section 5 feeds the second power supply voltage V2 to the sound circuit section 5 by the power of the battery 20.

The output from the battery 20 is connected to the DC/DC conversion (2) section 22 by way of the discharging switch 27. The DC/DC conversion (2) section 22 converts the output voltage of the battery 20 into the second power supply voltage V2. The second power supply voltage V2 is set to; e.g., about 5 V, which is a value lower than that of the first power supply voltage V1.

The power supply controller 24 monitors a value of an output voltage of the DC/DC conversion (1) section 21. When a determination is made that AC source 100 is disconnected as a result of detachment of the connector 7, or the like, the power supply controller 24 automatically switches the changeover switch 25 to a path for the DC/DC conversion (2) section 22.

As a result, the DC power to be fed to the sound circuit section 5 is switched from the first power supply voltage V1 to the second power supply voltage V2.

In addition, upon disconnection of the AC source 100, the power supply controller 24 sets the charging switch 26 to off, and the discharge switch 27 to on, thereby stopping charging of the battery 20; as well as feeding the sound circuit section 5 and other components with power of the battery 20. At this time, the output of the DC/DC conversion (2) section 22 (the second power supply voltage V2) is fed to the sound circuit section 5 by the power from the battery 20; and the DC power of a predetermined voltage value from the DC/DC conversion (3) section 23 is fed to the other components included in the electronic apparatus 1.

As described above, in the case where the AC source 100 is connected, the power supply section 2 of the electronic apparatus 1 feeds the sound circuit section 5 with the DC power having the first power supply voltage V1; e.g., about 15 V. In contrast, in the case where the AC source 100 is not connected, the sound circuit section 5 is fed with the DC power of the second power supply voltage V2; e.g., about 5 V, which is lower than the first power supply voltage V1, by the battery 20.

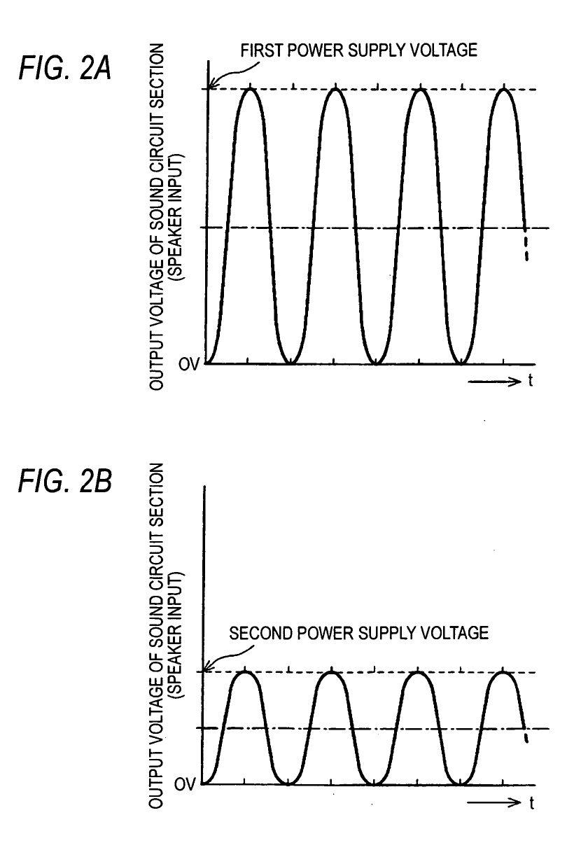

FIGS. 2A and 2B illustrate waveforms of audio signals output to the speaker 6 from the sound circuit section 5. For convenience of explanation, the audio signals are exemplified as sinusoidal waves.

FIG. 2A illustrates an output waveform in a case where the first power supply voltage V1 is fed as the DC power of the sound circuit section 5. FIG. 2B illustrates an output waveform in a case where the second power supply voltage V2 is fed as the DC power of the sound circuit section 5.

In general, in accordance with a request for reduction in size of a power source, or the like, the sound circuit section 5 employed in electronic apparatus, such as a notebook-type personal computer, is configured so as to be driven only by a single, positive power supply, rather than being driven by a bipolar, positive/negative power supply.

The maximum amplitude voltage of an audio output of the sound circuit section 5 driven by the single power supply is substantially determined by a power supply voltage fed thereto, which indicates a waveform varying within the range of 0 V and the power supply voltage.

Accordingly, when the first power supply voltage V1 is fed to the sound circuit section 5 as the power supply voltage, and the sinusoidal wave is input to the sound circuit section 5, the maximum amplitude voltage of the output from the sound circuit section 5 becomes, as illustrated in FIG. 2A, a sinusoidal output whose peaks are 0 V and the first power supply voltage V1. When, e.g., the first power supply voltage V1 is set to 15 V, a sinusoidal output whose peaks are 0 V and 15 V is obtained.

Meanwhile, when the second power supply voltage V2; e.g., about 5 V, which is lower than the first power supply voltage V1, is set as the power supply voltage of the sound circuit section 5, the maximum amplitude of the sound circuit section 5 indicates, as illustrated in FIG. 2B, a sinusoidal waveform whose peaks are 0 V and about 5 V.

The sound circuit section 5 has conventionally employed a power supply voltage of about 5 V. Accordingly, since the power supply voltage limits the amplitude of the output waveform, a high volume level has been difficult to realize. However, when the power supply voltage to be fed to the sound circuit section 5 is increased as is in the present embodiment, a speaker can be driven at a high volume level.

However, when the amplitude voltage of the audio waveform is increased as illustrated in FIG. 2A, power consumption by the speaker 6 increases. Accordingly, in a case where the electronic apparatus 1 is driven by the power of the battery 20, power consumption in the battery 20 increases which may cause shortage in the remaining charge of the battery 20.

To this end, the present embodiment employs the following configuration so as to realize a high volume level. That is, the AC source 100 is connected to the electronic apparatus 1; and constraints on power consumption are not of great concern, the power supply voltage to be fed to the sound circuit section 5 is set to high (the first power supply voltage V1).

Meanwhile, when the electronic apparatus 1 is driven by the power of the battery 20, the power supply voltage is lowered to a value (the second power supply voltage V2) which is substantially the same as that in the related art, thereby driving the speaker 6.

In the related art, the power supply voltage to be fed to the sound circuit section 5 has been set to a common value during a period in which the equipment is driven by the AC source 100 and a period during which the equipment is driven by the battery 20. Accordingly, in an attempt to avoid a shortage in the remaining charge of the battery 20, the power supply voltage to be fed to the sound circuit section 5 must be set to a predetermined value or lower. Hence, even when the electronic apparatus 1 is connected to the AC source 100, the user must accept a low volume level.

However, the electronic apparatus 1 according to the present embodiment employs the following configuration. That is, the sound circuit section 5 is fed with at least two types of power supply voltages, constituted of the first power supply voltage V1 and the second power supply voltage V2. By virtue of this configuration, when the AC source 100 is connected, the user can enjoy a high volume level; and during a period in which the equipment is driven by the battery 20, occurrence of shortage in the remaining charge of the battery 20 can be avoided.

Meanwhile, the two waveforms shown in FIGS. 2A and 2B respectively indicate waveforms of cases where audio signals of appropriate amplitudes have been input to the sound circuit section 5.

When a voltage gain; namely, a ratio between input amplitude and output amplitude, of the sound circuit section 5 during the period of connection with the AC source 100 and that during the period of power supply by the battery 20 are assumed to remain the same, the amplitude of a signal input to the sound circuit section 5 must be set to a large value during the period of connection with the AC source 100; and, in contrast, must be set to a small value during the period of power supply by the battery 20. The gain control section 4 in the block diagram of FIG. 1 is disposed to attain this setting. The power supply controller 24 performs control of the gain.

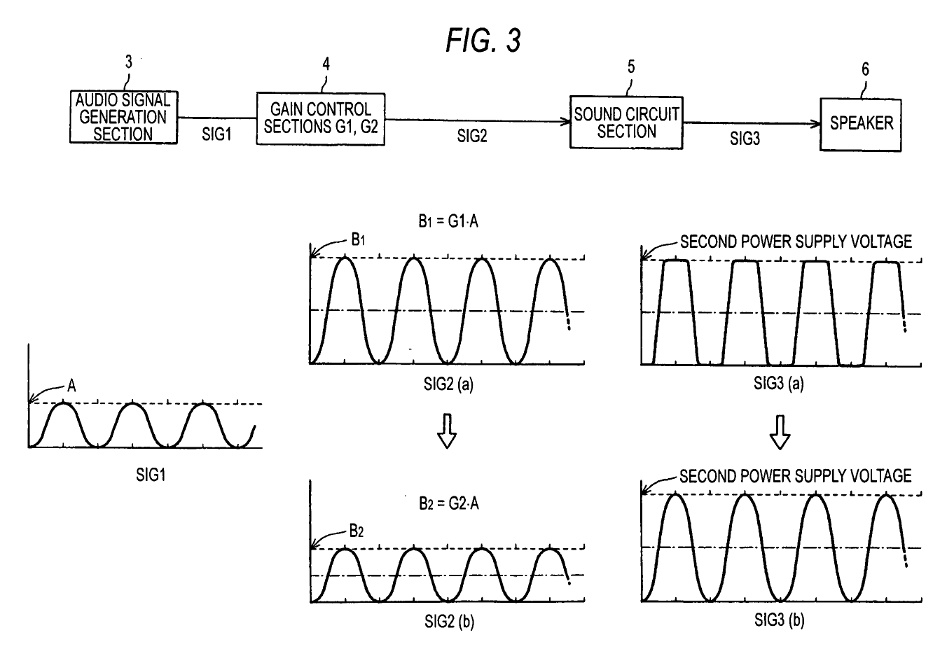

FIG. 3 is a view explaining operations of the gain control section 4. An audio signal output from the audio signal generation section 3 is input to the gain control section 4. The audio signal generation section 3 schematically denotes an audio generation source included in the electronic apparatus 1, and can be of various types. Examples of the audio generation section 3 include those where a recording medium, such as a CD-ROM, a DVD, and/or an HDD, is used as an audio generation source; and those where audio signals are obtained by using telecommunications and/or broadcasting, such as the Internet or television broadcasting, as a medium.

Audio signals output from the audio signal generation section 3 are represented by, e.g., a sinusoidal signal SIG1 whose peak values are 0 V and the amplitude A.

The signal SIG1 is input to the gain control section 4, where control of the gain is performed. More specifically, during the period of connection with the AC source 100, the gain of the gain control section 4 is set to G1; and during the period of power supply by the battery 20, the same is set to G2, which is lower than G1.

Consequently, the amplitude of an audio signal SIG2(a) to be input to the sound circuit section 5 during the period of connection with the AC source 100 ranges from zero to B1 (B1=G1•A); and the amplitude of an audio signal SIG2(b) to be input to the sound circuit section 5 during the period of power supply by battery 20 ranges from zero to B2 (B2=G2•A, B2<B1).

The amplitude of the signal SIG2(b) is set so as to match the amplitude of an output from the sound circuit section 5 when the sound circuit section 5 is driven at the second power supply voltage V2. More specifically, the amplitude of the signal SIG2(b) is set so that, when an audio signal having amplitude ranging from zero to B2 is input to the sound circuit section 5, the amplitude of the output from the sound circuit section 5 ranges from zero to the second power supply voltage V2 (the waveform shown in FIG. 2B or a waveform of SIG3(b) in FIG. 3).

Meanwhile, the amplitude of the signal SIG2(a) is set so as to match the amplitude of an output from the sound circuit section 5 when the sound circuit section 5 is driven at the first power supply voltage V1. More specifically, the amplitude of the signal SIG2(a) is set so that, when an audio signal having amplitude ranging from zero to B1 is input to the sound circuit section 5, the amplitude of the output from the sound circuit section 5 ranges from zero to the first power supply voltage V1 (the waveform shown in FIG. 2A).

When an input signal of large amplitude (the waveform of SIG2(a)) is input to the sound circuit section 5 during the period of power supply by the battery 20, as illustrated by the waveform of SIG3(a) in FIG. 3, the output from the sound circuit section 5 is clipped at zero and the second power supply voltage V2, whereby the waveform is distorted.

In contrast, when the gain control by the gain control section 4 is not performed, and an input signal of small amplitude (the waveform of SIG2(b)) is input to the sound circuit section 5 even during the period of connection with the AC source 100, only a small signal indicated by the waveform of FIG. 2B can be obtained from an output of the sound circuit section 5. Hence, a high volume level fails to be realized.

As described above, when the amplitude of an audio signal to be input to the sound circuit section 5 is switched, the speaker 6 can be driven at a high volume level during the period of connection with the AC source 100; and the same can be driven in a state of having no distortion in the waveform during the period of power supply by the battery 20.

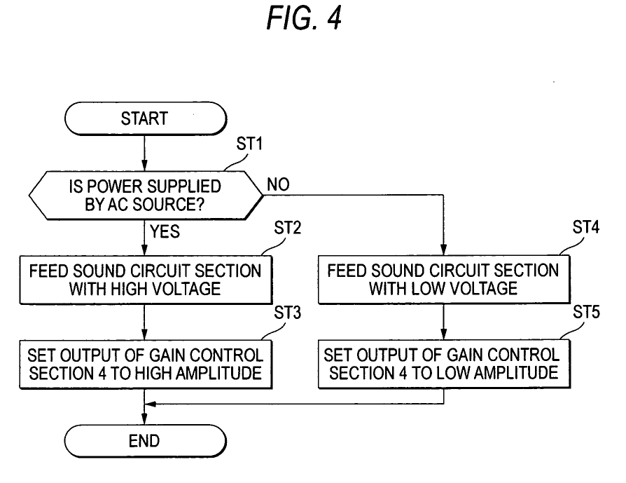

FIG. 4 is a flowchart illustrating a flow of processing performed by the power supply controller 24 of the power supply section 2.

First, in step ST1, the power supply controller 24 determines whether or not power is fed to the electronic apparatus 1 from the AC source 100. More specifically, for instance, the power supply controller 24 monitors an output voltage of the DC/DC conversion (1) section 21, thereby performing comparison with a predetermined threshold value, to thus make a determination.

If in step ST1 a determination is made that power is fed from the AC source 100 (connection with the AC source 100 is established) (the result of step ST1 is Yes), in the next step ST2, DC power of a high voltage (the first power supply voltage V1) is fed to the sound circuit section 5. More specifically, the changeover switch 25 is set to the bypass path.

Furthermore, the power supply controller 24 sets amplitude of an audio signal output from the gain control section 4 to high amplitude (B1 in the example illustrated in FIG. 3) (step ST3).

Meanwhile, if in step ST1 the power is determined not to be fed from the AC source 100 (power is fed from the battery 20) (the result of step ST1 is No), DC power of a low voltage (the second power supply voltage V2) is fed to the sound circuit section 5 in step ST4. More specifically, the changeover switch 25 is set to the DC/DC conversion (3) 23 path.

The power supply controller 24 sets amplitude of an audio signal output from the gain control section 4 to a low amplitude (B2 in the example illustrated in FIG. 3) (step ST5).

As described above, the power supply controller 24 detects connection/disconnection of the AC source 100, and automatically performs necessary processing, thereby eliminating loads in operations.

In the electronic apparatus 1 according to the first embodiment, as illustrated in FIG. 1, the sound circuit section 5 and the gain control section 4 are formed independently.

In a case of a mode in which the sound circuit section 5 incorporates a gain control function, the gain control section 4 can be incorporated in the sound circuit section 5.

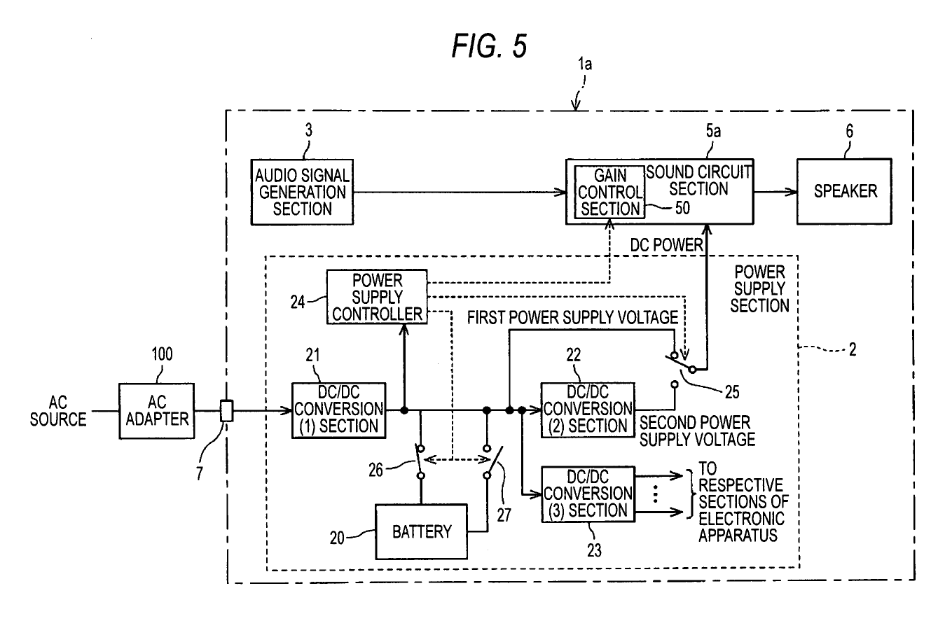

FIG. 5 illustrates a block section of electronic apparatus 1a according to a second embodiment in which a sound circuit section 5a incorporates a gain control section 50. The second embodiment is identical in configuration with the first embodiment, except for the sound circuit section 5a.

Operations of the gain control section 4 illustrated in FIG. 3 are implemented by operations of the gain control section 50 of the sound circuit section 5a. Meanwhile, in this embodiment, a gain control signal output from the power supply controller 24 is input directly to the sound circuit section 5a.

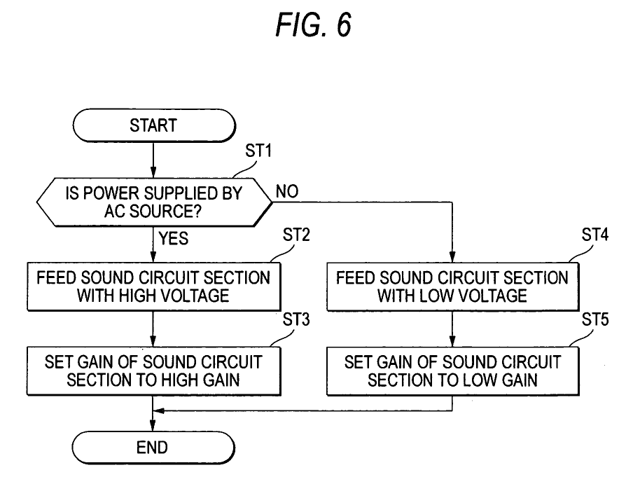

FIG. 6 illustrates a flowchart of processing performed by the power supply controller 24 in the second embodiment. The second embodiment is identical in flow of basic processing with the first embodiment. However, the flowchart in FIG. 6 differs from that in FIG. 4 in that processing for performing gain control with respect to the sound circuit section 5 is performed in steps ST3 and ST5.

Although not illustrated, there may be employed another embodiment in which the speaker 6 is omitted from the block diagram shown in FIG. 6.

For instance, some portable audio equipment, or the like, is configured such that a user enjoys music with a low-power headphone while walking; and enjoys music indoors at a high volume level by connecting the equipment to an AC adapter and an external speaker.

The first or second embodiment a can also be applied to an electronic apparatus, such as the above-described portable audio equipment. When the embodiment is applied, the sound circuit section 5 can be driven with power from the battery 20 at the second power supply voltage V2 while away from home; and the speaker 6 can be driven indoors at a high volume level by driving the sound circuit section 5 at a high voltage (the first power supply voltage V1) by the AC source 100.

Meanwhile, the invention is not limited to the above-described respective embodiments, and, when being practiced, can be implemented while modifying the constituent elements in various manners without departing from the scope of the invention. Moreover, a variety of inventions can be formed by appropriately combining a plurality of constituent elements disclosed in the respective embodiments. For instance, some constituent elements may be omitted from those described in the embodiments. Moreover, constituent elements used in different embodiments may be combined appropriately.

What is claimed is:

1. An electronic apparatus comprising:
a speaker;
a sound circuit section that drives the speaker; and
a power supply section which is powered by an AC source, which comprises a battery, and which can feed DC power to the sound circuit section by power of the AC source or the battery, wherein when the DC power is fed by the AC source, the power supply section feeds the sound circuit section with a first supply voltage supplied from the DC power,
wherein when the DC power is fed by the battery, the power supply section feeds the sound circuit section with a second supply voltage which is supplied from the battery, and
wherein the second supply voltage is lower than the first supply voltage.

2. The electronic apparatus according to claim 1, wherein the first power supply voltage is a voltage at which the speaker can be driven at a predetermined volume level, and
wherein the second power supply voltage is a voltage at which the speaker can be driven without causing shortage in a remaining charge of the battery.

3. The electronic apparatus according to claim 1, wherein, when the power supply section is connected with the AC source is established, the power supply section feeds the DC power by the AC source, and
wherein, when the power supply section is connected with the AC source, the power supply section feeds the DC power by the battery.

4. The electronic apparatus according to claim 3, wherein the power supply section detects connection/disconnection of the AC source, and
wherein the power supply section can automatically switch between the AC source and the battery so as to feed the sound circuit section with the DC power.

5. The electronic apparatus according to claim 1, further comprising:
a gain control section that can control amplitude of an audio signal to be input to the sound circuit section,
wherein, when the DC power is fed by the AC source, the gain control section sets a gain of the gain control section to a first gain, and
wherein, when the DC power is fed by the battery, the gain control section sets a gain of the gain control section to a second gain which is lower than the first gain.

6. The electronic apparatus according to claim 5, wherein the first gain is a gain at which the speaker can be driven at a predetermined volume level, and
wherein the second gain is a gain at which an output of the sound circuit section is not saturated.

7. The electronic apparatus according to claim 1, wherein the sound circuit section is configured to be capable of changing a gain, and
wherein when the DC power is fed by the AC source, a gain of the circuit section is set to a first gain, and
wherein, when the DC power is fed by the battery, a gain of the circuit section is set to a second gain which is lower than the first gain.

8. The electronic apparatus according to claim 7, wherein the first gain is a gain at which the speaker can be driven at a predetermined high volume level, and
wherein the second gain is a gain at which an output of the sound circuit section is not saturated.

9. An electronic apparatus comprising:
a sound circuit section that drives a speaker disposed on an outside; and
a power supply section which inputs AC power and which includes a battery, and which feeds DC power to the sound circuit section by power of the AC source or the battery, wherein, when the DC power is fed by the AC source, the power supply section feeds the sound circuit section with the DC power of a first power supply voltage, and
wherein, when the DC power is fed by the battery, the power supply section feeds the sound circuit section with the DC power of a second power supply voltage which is lower than the first power supply voltage.

10. The electronic apparatus according to claim 9, wherein the first power supply voltage is a voltage at which the speaker can be driven at a predetermined volume level, and
wherein the second power supply voltage is a voltage at which the speaker can be driven without causing shortage in a remaining quantity of the battery.
